(19) United States
(12) Patent Application Publication
(10) Pub. No.: US 2012/0209669 A1
(43) Pub. Date: Aug. 16, 2012

(54) CONFIGURABLE ADVERTISING AND CONTENT RENDERING

(76) Inventor: Carl Zealer, Canal Winchester, OH (US)

(21) Appl. No.: 13/371,943

(22) Filed: Feb. 13, 2012

Related U.S. Application Data
(60) Provisional application No. 61/441,989, filed on Feb. 11, 2011.
(60) Provisional application No. 61/443,417, filed on Feb. 16, 2011.
(60) Provisional application No. 61/528,308, filed on Aug. 29, 2011.

(51) Int. Cl. G06Q 30/02

(52) U.S. Cl. 705/14.1; 705/14.4

(57) ABSTRACT

Systems and methods that facilitates advertising of products are disclosed. Such a system can include a rendering component that visually displays an item of content associated with the product and a content management component that provides the item of content to the rendering component. The system can retrieve and display content by way of an on-board memory, Internet (or network) source, peer-to-peer source or the like. The content can be related to a product review, preview, instructions or the like.

### CROSS-REFERENCE TO RELATED APPLICATIONS

This application claims the benefit of the following U.S. Provisional Patent Applications: Ser. No. 61/441,989 entitled “ADVERTISING SYSTEM AND METHOD THEREOF” and filed Feb. 11, 2011; Ser. No. 61/443,417 entitled “PACKAGE-BASED ADVERTISING AND CONTENT RENDERING” and filed Feb. 16, 2011; and Ser. No. 61/528,308 entitled “PACKAGE-BASED ADVERTISING AND CONTENT RENDERING” and filed Aug. 29, 2011. The entireties of the above-noted applications are incorporated by reference herein.

### BACKGROUND

Signs, banners and other promotional items are often used to advertise items. Additionally, audio/visual means (e.g., commercial and infomercials) are sometimes used. As multi-media systems become more economical to use, many companies and retailers are moving to the use of in-store video monitors to promote products and services.

A television advertisement or television commercial refers to a portion of programming produced and paid for by an organization that conveys a message, most often promotion of a product or service. The vast majority of television advertisements today consist of brief advertising spots, ranging in length from a few seconds to several minutes, as well as program-length infomercials.

As the effect of commercial advertisements upon the viewing public has been successful and pervasive, many retailers have begun shifting to the use of in-store multi-media means to advertise and promote products within a retail environment. Unfortunately, these mechanisms are often cumbersome and costly to maintain. As well, product packaging remains conventional using standard artwork on the box, label or packaging.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system a system that facilitates advertising of a product, that can include a rendering component that visually displays an item of content associated with, or based upon, the product and a content management component that provides the item of content to the rendering component. The rendering component can be used to render product reviews, previews, instructions or the like. In operation, a user can easily change content that is rendered via the display (e.g., LCD screen), speakers, etc. Additionally, content management component can be configured to detect or determine content based upon a product associated therewith. Still further, content updates or changes can be transferred wirelessly, for example, via the Internet, Bluetooth, or the like.

In other aspects, the innovation can include a method of facilitating marketing of a product. Such a method can include the acts of providing a rendering device that displays one of a plurality of content items associated with a product and configuring at least one of a plurality of content items for rendering via a rendering device, wherein the plurality of content items comprises at least a preview related to the product and instructional material related to the product. The method can also include the acts of determining a selected content item of the plurality of content items to render via the rendering device and rendering the selected content item via the rendering device.

In various aspects, the innovation can detect presence of an individual thereby triggering rendering(s) at an appropriate time to maximize advertisement effect. Further, the system can be manufactured and provided in a manner such that the equipment is disposable or otherwise recyclable as desired. In yet other aspects, the innovation can be provided and used upon bulk vending machines, specialty vending machines or the like. It will be understood and appreciated that alternative uses of the innovation have been contemplated and are to be included within the scope of the innovation and claims appended hereto.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of an advertisement system in accordance with an aspect of the innovation.

FIG. 2 illustrates an example content management component in accordance with various aspects of the subject innovation.

FIG. 3 illustrates an example embodiment of a system of the subject innovation used in connection with a vending or dispensing machine.

FIG. 4 illustrates an example flow chart of procedures that facilitate advertisement in accordance with an aspect of the innovation.

FIG. 5 illustrates an example package-based advertisement system in accordance with aspects of the innovation.

FIGS. 6A-6B illustrates an example security case package-based advertisement system in accordance with aspects of the innovation.

FIG. 7A illustrates an example package-based advertisement in accordance with aspects of the innovation.

FIG. 7B illustrates an example package-based advertisement in accordance with aspects of the innovation.

FIG. 8 illustrates an example block diagram of a product advertisement system in accordance with an aspect of the innovation.

FIG. 9 illustrates an example flow chart of procedures that facilitate product advertisement in accordance with an aspect of the innovation.

FIG. 10 illustrates a product advertisement system in accordance with aspects of the innovation.

FIG. 11A illustrates an example product advertisement system in accordance with aspects of the innovation.

FIG. 11B illustrates an example product advertisement in accordance with aspects of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

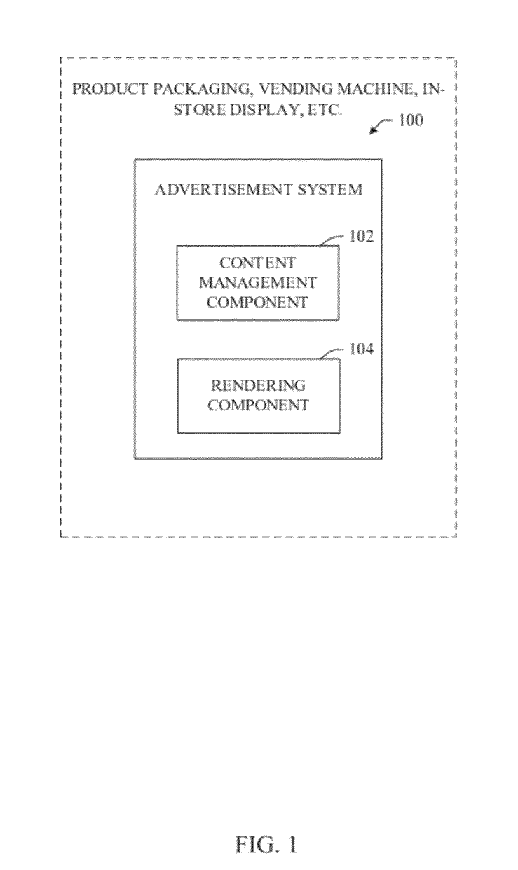

Referring initially to the drawings, FIG. 1 illustrates an example block diagram of an advertisement system 100 in accordance with aspects of the innovation. Generally, system 100 can include a content management system 102 that can determine content (e.g., one or more items of content or content items) to render as described in greater detail herein, and can provide the determined content to a rendering component 104 that can render the determined content (e.g., content can be rendered by one or more of a visual display such as via a screen, etc., or audio such as via speakers, etc., or via other senses, such as providing scents to promote fragrances, dispensing samples in connection with food or drinks (e.g., which can be according to the rewards and related techniques discussed herein, etc.)). In aspects, system 100 can provide for advertisements, promotional material, or other content, and embodiments can be configured (and optionally reconfigured) to render a variety of content for a product (or service, etc.; although the discussion herein, in accordance with aspects discussed herein. System 100 can be used in a variety of settings in connection with goods and services. In various embodiments, as indicated by the dashed line around system 100, system 100 can be placed in proximity to products or services, and the determined and rendered content can be related to or based at least in part on the proximal products or services. In one example, system 100 can be applied to product packaging so as to enable rendering of reviews, previews, instructions, promotions of related products or products offered by the same company, or the like related to a product, so as to enhance consumer information and experience. In another example, system 100 can be used in connection with a vending machine or the like to provide promotional or other information about, or related to, items within the vending machine, etc. In further embodiments, system 100 can be provided on or near an in-store or similar product display (e.g., near shelving, hanging displays, standing displays including stand-alone displays in or separate from a store (e.g., a kiosk in a mall, etc.), etc.).

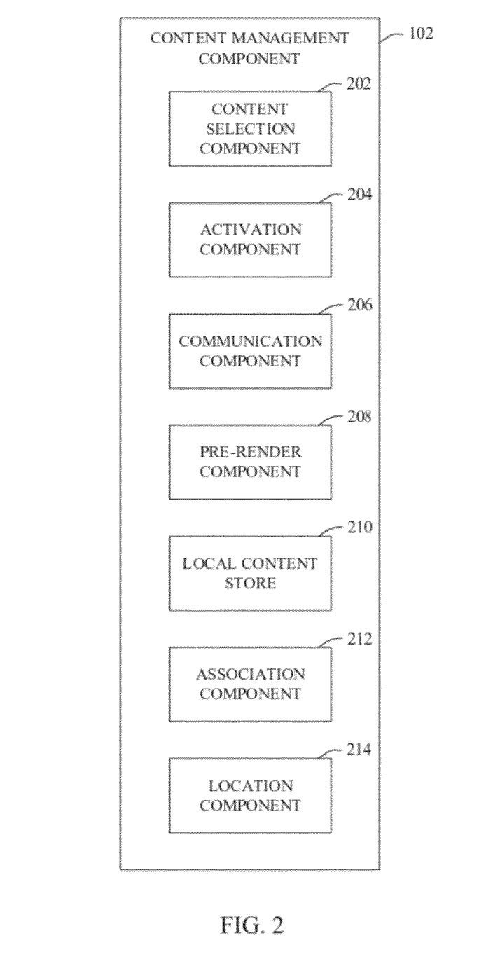

FIG. 2 illustrates an example content management component 102 in accordance with various aspects of the subject innovation. In various aspects, a content management component 102 in accordance with the subject innovation can comprise none, some, or all of the optional sub-components shown in FIG. 2. As shown, in some embodiments, content management component 102 can comprise one or more of: a content selection component 202 that can select or determine one or more items of content to be rendered; an activation component 204 that can activate rendering component 104 to render the content; a communication component 206 that can send and/or receive one or more of content or information related to content that can be rendered by system 100; a pre-render component 208 that can modify content or prepare content for rendering by rendering component 104; a local content store 210 that can comprise a memory, data store, etc. that can store one or more items of content locally; an association component 212 that can employ targeted advertising to identify one or more items of content that can be selected by content selection component 202; and a location component 214 that can determine or store a location of the system 100 and provide information associated with the location to the content selection component 202. Other components can be included (e.g., means to dispense a scent such as via an automatic spray, etc.). In various aspects, some or all of these components can be co-located with one another or with other portions of system 100 (e.g., a power supply combined with memory, etc.).

Content selection component 202 can select content for system 100 to render in any of a variety of ways in aspects described herein. In some embodiments, content can be provided in connection with system 100, such as via a memory device (e.g., volatile or non-volatile memory; optical, magnetic, solid-state, etc.), for example, a memory card (e.g., a secure digital (SD) card, etc.), stick (e.g., universal serial bus (USB) or other memory device, etc.), such as local content store 210, which can store one or more items of content. In some aspects, memory comprising content can be provided with a shipment of products. Additionally or alternatively, content can be obtained via communication component 206, such as from the Internet, a local network, peer-to-peer, etc., and can be obtained in a wired (e.g., Ethernet, etc.) or wireless (e.g., Bluetooth, Wi-Fi, radio frequency identification (RFID) devices, etc.) manner. Selection of content by content selection component 202 can be based on any of a number of factors described herein, including information received from one or more other components shown in FIG. 2, as well as upon input from a user (e.g., consumer, employee, etc.).

In some embodiments, content can be selected from content provided in connection with a power supply, such as a combination battery and content store 210, whereby replacement of the power supply (e.g., battery, etc.) can be an opportunity to update content to be selected from. In aspects, such as the rewards discussed further herein (and discounts, coupons, or special offers, each of which can employ similar techniques), content selection can be based on one or more random or periodic factors, such as a small chance (or once every so many units, only after a period of time, etc.) of extending a prize, special offer, discount, etc., to a customer as the content selected to be rendered. In one such example, such content can be selected for rendering for a limited period of time (e.g., “25% off if purchased in the next 30 minutes,” etc.) to incentivize purchase, whereupon content selection component 202 can select other content, revert to a default mode, never display the offer again, or other options. In some aspects, access to such prizes or offers can be limited as described further herein to discourage attempts to circumvent its random or periodic nature.

Activation component 204, in aspects, can control activation or deactivation of the rendering component 104, such that content can be rendered based at least in part on any of: one or more conditions existing (or not), one or more events occurring (or not), time, random factors (e.g., random number generation, etc.), or other factors. For example, activation component 204 can comprise a motion detector such that when a potential customer approaches within a given distance of system 100, activation component 204 can activate rendering component 104 such that content is presented (e.g., as audio, video, etc.). In other aspects, activation or deactivation can occur based at least in part on user action (e.g., pressing a button, flipping a switch, picking up a product via sensed movement, etc.). Additionally or alternatively, in aspects, content can be rendered continuously or only every so often (e.g., once every few minutes, etc.).

Communication component 206 can be included in content management component to send or receive data to or from system 100 according to various embodiments. This data can be related to items of content, products, or other information, and can be transmitted in a wired or wireless manner, and can involve the Internet, a local or private network, peer-to-peer network, etc. In various embodiments, an application programming interface (API) can be utilized to facilitate sending or receiving data. In some aspects, communication component 206 can obtain content from a remote server, which can be based at least in part on other information received. For example, in various aspects, information can be received locally regarding one or more products to be associated with system 100 (e.g., entering information via an input device separate from or included within system 100, receiving information automatically, etc.), and based on the locally received information, communication component 206 can query a server for appropriate content associated with that product, the server can send the content to the product, and communication component can prepare the content for selection, rendering, or other actions (e.g., by sending to a local content store 210, by sending to rendering component 104 such as with streamed (live or prerecorded) content, etc.).

In various examples, communication component 206 can receive information from devices or information attached, embedded or included within the product (e.g., computer, game, music, movie disk or other product). This information can be identifying information, and a product or product package can be identified by obtaining information such as a unique property identifier (e.g., via information stored on an RFID device stored on the product or provided with the product upon delivery, by scanning a 1D bar code or 2D bar code (e.g., a Quick Response (QR) code, etc.), obtaining a stock-keeping unit (SKU) number or code, etc.). This information need not be (but can be) obtained directly by communication component 206, but can be obtained elsewhere and sent to communication component 206, such as by scanning a bar code and relaying the information in a wired or wireless manner to communication component 206 (e.g., by scanning the item, and then scanning a portion of system 100, entering identifying information, or otherwise indicating to which system information should be sent, etc.), sending it from a computer, mobile device, etc. (including one communicatively coupled to a plurality of systems such as system 100, such that a store can manage a plurality of such systems from such computer, mobile device, etc.), including via a mobile application (or “app”) such that a user can take a picture of product identifying information, optionally selecting or otherwise indicating a particular system 100 (including by taking a picture of identifying information such as a bar code, etc. associated with the system) such as if more than one are associated with a store, etc., and relaying information such that communication component 206 can obtain appropriate content (e.g., from the Internet, from a server, from a library of content stored locally such as on a local memory store 210, etc.).

Alternatively, content can be retrieved by the computer or mobile device and provided to communication component 206, such as according to the above description, or through selection of content (e.g., from among a library of content on a server, etc.). In some aspects, proximity to an RFID device, etc. of a product can automatically (e.g., via periodic querying, etc.) trigger communication component 206 to obtain content, or the product can be placed in a specific location relative to system 100 (which can prevent accidental or unintended content obtention, e.g., if a customer brings another product within proximity of system 100). In other aspects, content can be directly pushed to a system 100 via communication component 206 and optionally activation of system 100 and/or rendering of that content can occur as a result, such as for rendering of live material, etc. Content provided through communication component 206 (or otherwise, e.g., shipped to a store, etc.) can be provided in connection with a subscription or account-based service, such that a user can receive content and content updates associated with products according to the terms of some agreement. For example, a user can set up an account and receive one or more of systems associated with the subject innovation or content or other information for such systems, and the account can provide access to the content, such as through a server, shipments, etc.

Pre-render component 208 can prepare content for rendering in a variety of ways. Pre-render component 208 can facilitate efficient programming or loading of electronic content for rendering, for example via a display or monitor, speakers, etc. (e.g., rendering component 104). The content can be provided and rendered in any of a variety of formats (e.g., any of a variety of formats as appropriate to the content, which can include, depending on the content, one or more of, audio formats such as .mp3, etc.; video formats such as movie (e.g., .mov, etc.) or picture (e.g., .jpg, etc.) (e.g., comprising a slide show, etc.) formats, etc.), including formats both known or proprietary. Although specific examples are listed, it is to be understood that other formats can be used additionally or alternatively.). The content, e.g., video, advertisement, review, preview, instructions, how to's, etc., can be swapped if necessary as described herein, and pre-render component 208 can prepare content either once, each time it is rendered, etc.

In some embodiments, depending on the nature of the rendering component 104, pre-render component 208 can prepare content for rendering in a way that does not preserve all information (e.g., lower sampling or frame rate, lower bit depth, less channels, etc.), for example in connection with a smaller screen, lower quality speakers, etc. In other aspects, content can be initially provided to specific embodiments of system 100 with settings appropriate for system 100 (e.g., by determining appropriate settings either initially or in connection with providing content, etc.). In another example, in some embodiments, ambient levels of lighting or noise can be sensed, and visual or auditory properties of the content can be adjusted dynamically by pre-render component 208 based at least in part on such levels.

Additionally, pre-render component 208 can modify content to be rendered by inserting specific information, such as time, location, customer specific information (on an opt-in basis, to preserve privacy), store specific information, and other information (e.g., information received from other components such as location component 214, association component 212, etc.) into content. For example, a product that is currently subject to a sale can render content modified to include information (e.g., as a frame as discussed below, as fixed or scrolling text, etc.) about the sale, potentially a limited duration of the sale, etc. In other aspects, for a customer who opts in, special offers or personalized information can be provided to the customer, e.g., based on detecting an RFID or other device the customer can choose to carry, and querying information either provided by the customer or about the customer (e.g., purchasing habits, associations with other customers who opted in and their purchasing habits, etc., the use of which can be subject to customer approval, modification, etc.). Content can also be modified based on local information that can be provided by a store or other entity associated with the product or products, information determined based at least in part on a location determined by location component 214, etc.

Local content store 210 can store content renderable in connection with system 100, as well as other information described herein in connection with systems and methods of the subject innovation. Alternatively or additionally, remote storage can be used for some or all data, and accessed via a communication component 206, including storing data at or near a store, etc., or cloud storage, etc. Any of a variety of types of storage can be used, including various implementations of optical (e.g., CD, DVD, etc.), magnetic (e.g., hard drive, etc.) or solid-state storage devices (e.g., SD card, USB flash memory device, etc.) described herein. In aspects, local content store 210 can be readily removable or updatable, or, in other embodiments, removal and/or update can be more difficult. In various embodiments, replacement of local content store 210 or the data thereon can occur in situ, such as at a store, while in other embodiments, system 100 can be returnable, whereby local content store 210 or the data thereon can be replaced (e.g., by swapping in a new local content store 210, by replacing one or more items of content stored on local content store 210, etc.).

Association component 212 can determine one or more associations that can be used as a basis to determine content to be obtained (e.g., via communication component 206, local content store 210, etc.), or information that content can be modified to include, personalized, etc. (e.g., via pre-render component 208, etc.). On such a basis or others described herein in connection with association component 212, association component 212 can assemble, modify, or add to a plurality of content items available for selection from by content selection component 202 (other components described herein can similar assemble or present items of content to content selection component 202). For example, for certain products, other products can be determined to be frequently purchased in connection with them (e.g., people purchasing printers may need printer cables, ink, paper, etc.; people purchasing a Blu-ray player may want Blu-ray discs, etc.), and information in connection with these other products can be determined and obtained (e.g., via communications component 206, etc.).

In other aspects, customers can opt-in or sign up for a rewards or other account associated with a store, wherein promotions, offers, etc. can be personalized to the customer. Some embodiments of system 100 can determine customer-specific content (or modify more generic content to be customer-specific, e.g., via pre-render component 208, etc.) to render to the customer, such as upon detection of an RFID or other device a customer may choose to carry. As examples, offers, rewards, etc. can be personalized to customers and presented to them in store near products associated with those offers, rewards, etc., which can be based at least in part on information associated with the customer. Association component 212 can determine content or modifications to content based at least in part on a location (e.g., as determined by location component 214, or as recorded in a local data store 210, etc.) of the system (e.g., with varying levels of specificity, such as region, city, mall, etc.), demographics (e.g., associated with the store generally, customers frequently purchasing such items, a specific customer that chooses to opt-in, etc.), a time (e.g., offering content specific to a time of year such as a holiday, a time of day such as dinner-time, etc.), related products, customer membership information, etc.

Location component 214 can determine the location of system 100. In various aspects, global positioning system (GPS) can be used, or information can be used based on a plurality of RFID or similar devices, such as by including a plurality of such devices in a store. A unique identifier of each such device (unique relative to the other devices in the location, or globally unique, etc.) can be associated with a location (e.g., device one is near the north exit, device two is near the east end of aisle nine, etc.), and the location of system 100 can be determined based on locations associated with nearby devices. In aspects, location information (as obtained from any source) can be overlayed on a map of a store, such that customers can be provided with visual directions toward one or more locations of interest (e.g., location of a register to purchase the item, location(s) of other items frequently purchased in connection with the item, locations of other items suggested for a customer, etc.). In other aspects, when a location of a product is determined to have moved from a designated location (e.g., where it was stocked, etc.), some or all content rendered can change (e.g., from advertising or promotional material, and to indicate products a consumer might want in connection, to indicate a location of a register, etc.).

In some embodiments, system 100 can be used in connection with a vending or product dispensing machine, such as described further herein. For example, content (e.g., video, audio, etc.) can be provided that advertises or promotes one or more products associated with the machine. This information can be pre-determined (e.g., a specific machine can be designated to vend or dispense specific product(s), obviating the need for the system to be modifiable on site (although it can be capable); can be updated (e.g., by replacing a local content store 210, such as a memory card, stick, combination power supply and memory, etc.) on-site, or via return to a distributor, etc.; or content can be selected based on a determination of the product(s) associated with the machine (e.g., by determining one or more products contained within or associated with the machine, such as by user selection, detection via RFID or other device, bar codes, or other techniques discussed herein).

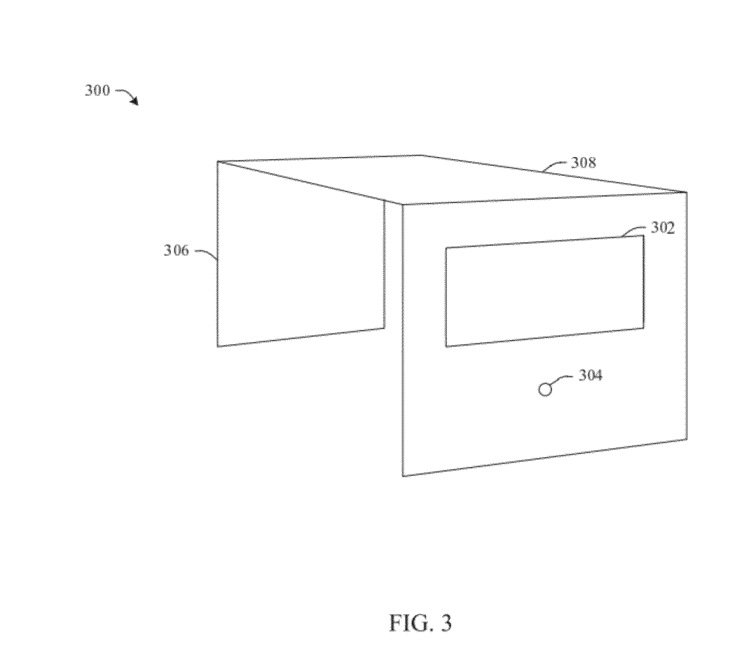

FIG. 3 illustrates an example embodiment of a system 300 of the subject innovation used in connection with a vending or dispensing machine, such as by being placed atop such a machine, on the side, or otherwise in connection with the machine. As shown, system 300 can comprise a rendering component 302 that can include a screen, a motion sensor 304 that can activate system 300 upon detection of someone within proximity of it (e.g., two feet, three feet, etc.), and a battery 306 that can provide power to system 300. In aspects, some portion of system 300, for example, portion 308, can act as a lid for a dispensing machine, although in other embodiments, the configuration of system 300 or other similar embodiments can vary (e.g., in terms of the selection and arrangement of components, etc.).

As another example embodiment, system 100 can be employed as part of the packaging of a product (e.g., clipped on, such as magnetically, mechanically, etc., built into the packaging, stored internally to the outer packaging but visible/audible through the packaging, etc.) or as part of the product, and one or more items of content (e.g., one or more of video, audio, etc.) as described herein can be provided based at least in part on the product, which can include one or more of: promotional material for the product (e.g., advertisements, reviews, product features, pricing, previews or samples (e.g., audio or video clips, etc.), etc.), additional material related to the product (e.g., set-up instructions, user guide, etc.), promotional materials for one or more related products (e.g., other products by the same company, other products frequently used in connection with the product, etc.), or information to assist a customer in their shopping experience (e.g., displaying information detailing where other products can be obtained (e.g., for a printer, information about where any of ink, paper, cables, etc. can be obtained in the store; in aspects, this information can comprise locational information such as a map detailing one or more of store features (e.g., locations of aisles, doors, registers, etc.), the product's current location, the location of other products, etc.).

In a further example embodiment, a user can carry or otherwise travel with an embodiment of system 100 along with the user (e.g., by pushing a shopping cart with system 100 the user, etc.), such that as a user changes locations in a store, mall, trade show, etc., system 100 can identify content associated with its present location. For example, this content can be via one or more RFID devices stored in or near products that system 100 can then come in proximity with and obtain content either therefrom or as a result of identifying information received therefrom. In another example, location information can be received, such as via GPS or RFID devices, and that can be associated with content. As an illustration, specific locations can be identified, such as various portions of a store, mall, trade show, etc. that have content associated with those locations (as examples, a store manager might identify types of products or specific products with various aisles or portions of aisles in a store; vendors registering for a trade show can have content related to their products associated with their location in the trade show; etc.). In some aspects, system 100 can also provide further information, including user-provided information, such as presenting a shopping list of the user (e.g., as input on location, scanned or read in by proximity of system 100 to a fob, RFID device, user membership bar code, etc., wherein identifying a rewards or membership account can provide for retrieval of such a list from a remote server or the Internet, such as a list a user entered at home or elsewhere via a computer, mobile device, etc.). Such a system 100 ca use location information over a short period of time to identify whether a user has stopped or slowed in a location, and provide additional information about nearby products. In addition, when presenting content associated with nearby products, this content can include coupons, offers, etc. associated with such products. Additionally, in aspects where a user is identified (e.g., by choosing to sign up for a reward or membership account, etc.), products that the user has previously purchased as well as associated products or products determined to be likely to be purchased by the user can be emphasized when delivering content so as to personalize the content.

In embodiments with multiple items of content, selection between these items can be based on automatically cycling between or random selection from among one or more items of content (e.g., when active, rendering one or more items, such as an advertisement, a review, and information about other related products, etc.). Additionally or alternatively, users can select or cycle between one or more items of content (e.g., via one or more controls such as buttons, including non-reversible actions such as removing a pull-tag, etc.). In some aspects, one or more items of content can be one of only displayed before or only displayed after a triggering event, such as removal of a pull tag, purchase of the product (e.g., as conveyed via removal of a pull-tag, display case, or anti-theft device, deactivation of an anti-theft device, communication with a register or other device in a store, etc.), such as displaying information more relevant to a potential consumer (e.g., advertising, etc.) prior to the event, and information more relevant to an owner after the event (e.g., installation, set-up, user guide, etc.).

In further examples, embodiments of the subject innovation can be used in connection with product displays or stands or otherwise near or in connection with products.

Depending on the nature of the information stored or rendered, one or more components of system 100 or content management component 102 as described herein may be included, for example, a location component 214 to provide location information, a communication component 206 or replaceable or updatable local content store 210 to update content, etc., while in other embodiments these components would not be necessary. Some of the information described in connection with examples or various embodiments does not need to depend on more than the product and fixed information (e.g., instructional material, product association information, etc.), and embodiments utilizing only such information need not include the capability for content to change after creation of the system.

In various embodiments, systems of the subject innovation can be removable, such as by affixing them mechanically or magnetically (e.g., clipping or snapping on, etc.), whereby they can be attached to another location, machine, display or product.

It is to be appreciated that the product-based advertising system can be applied to most any product or product dispensing device. For instance, the product-based advertising system can be applied to bulk vending machines whereby an advertisement can be rendered to a consumer (or potential consumer). As will be understood, this system can enhance the effect of advertisements in bulk vending scenarios.

In some aspects, the device can detect a dispensed product from the bulk vending machine and accordingly render an advertisement that corresponds with the product. It will be appreciated that the product as described herein can be employed both pre- and post-sale.

Further, as described herein, the screens and/or monitors associated with the product can be preprogrammed with content associated with a particular product or group of products. Additionally, batteries can be reusable, rechargeable, sealed or otherwise disposable. In some aspects, the innovation can employ a “recyclable” or otherwise “disposable” model. In each of these models, once a monitor or rendering device expires (e.g., battery drains), the monitor can be returned to a manufacturer or supplier to be recharged or re-powered. Similarly, if a user desires to use the rendering device or advertising system to correspond to a different product than originally programmed, the unit can be returned to a manufacturer or supplier for reprogramming in some aspects. In other aspects, it is also possible for the unit to be reprogrammed in the field or even remotely in some instances.

While specific aspects are described herein, it is to be understood that alternative aspects can include features such as removal alarms (in the event that an advertisement tag or screen is removed from a product, machine or display). Additionally, the screen can be provided with attachment means such as swivel or pivotable hangers can be employed to efficiently attach a rendering device (e.g., one or more of a screen, speakers, etc.) to a display, dispensing machine, or product.

Still further, it will be understood that a button or other triggering switch or mechanism can be provided so as to enable a user to start the rendering of material (advertisement or video). In these aspects, it will be appreciated that the system or product packaging or housing can be manufactured in such a manner that a recess(es) or indentation(s) can be strategically employed so as to effect stackability of housings (e.g., tags). For example, this stackability feature will inherently keep the buttons in a desired position (e.g., off) so as to alleviate inadvertent activation and thereby inadvertent power usage. Here, this stackability will be very helpful in manufacturing, shipping and inventory so as to retain battery power.

Further, in use, the cycling of an advertisement can be limited or delayed so as to prohibit a user from repeatedly running a video thereby draining power. In some aspects, a random prize or reward can be given to a viewer should they view the video when the randomizer renders a prize code (e.g., based on content management component 102 providing such a code to rendering component 104, etc.). In some aspects, the user will have to redeem the prize code on a particular website. In other aspects, the prize code can be redeemed at the place of purchase. To prohibit a user from repeatedly pressing the video to get a chance to win, a delay can be programmed such that the video can only be viewed at a particular time, e.g., every 3 minutes. In other aspects, the prize code can be associated with a membership or reward account that is user specific, which can be used to ensure that a user can receive only a certain number of rewards. These and other aspects are to be included within the scope of the innovation and claims appended hereto.

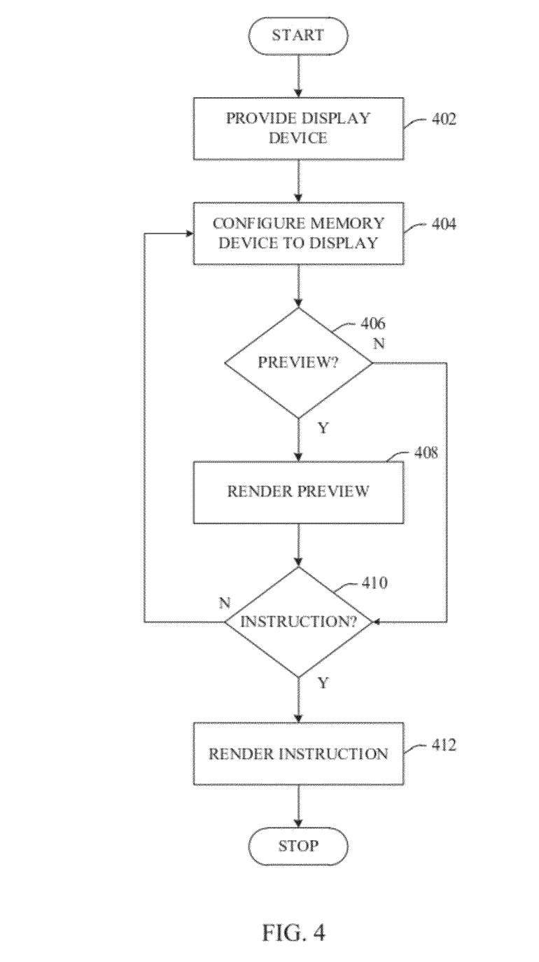

FIG. 4 illustrates a methodology of configuring an advertisement system in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 402, a display device such as an LCD monitor or the like can be provided for display of an advertisement, review, preview, instruction, etc. At 404, content can be configured for rendering. For example, content can be retrieved from an on-board memory, a product-based communication means such as an RFID tag or the like. In some aspects, the display devices can be pre-installed into the packaging of an item, a display, vending or dispensing machine, etc.; while in other aspects, display devices can be inserted into a product or attached to a display or machine after the fact, for example, as a promotional sales tool, etc. It will be understood that most any memory mechanism can be employed to load or insert content into the system.

A decision can be made at 406 to determine if a preview should be shown. For example, at 406, a push button, switch, motion sensor or the like can be used to trigger display of a product preview. Similarly, a pull tab can be used to establish if a preview or other content should be displayed. If, at 406, a preview is desired, the system can render a preview at 408. However, if a preview is not desired at 406, the system can jump to 410 to determine if an instruction (or other content) should be rendered. If, at 410, instruction content is not to be displayed, the system can return to 404 to configure memory for display. Here, the system can wait for another trigger to render content.

If, at 410, the system determines that instructions are to be rendered, the instructions can be displayed at 412 as shown. While previews and instructions are shown and described in accordance with the methodology of FIG. 4, it is to be understood that other aspects can render most any content related to a product or use of a product, including variations involving more or less items of content, or display based on other factors discussed herein. For instance, in some other aspects, alternative or ancillary products can be rendered upon a display. For example, on or in connection with a video game (e.g., NFL football) product, the system can render a preview or suggestion of an alternate game (e.g., NCAA football) having similar properties or experiences, or a controller or accessory to use in connection with the game, etc.

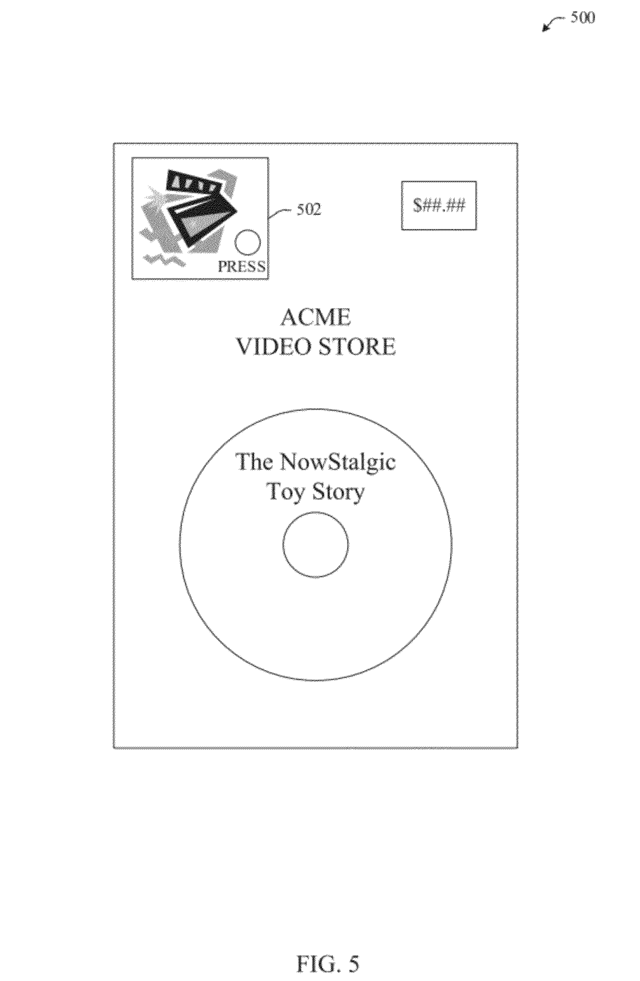

Referring now to FIG. 5, an example embodiment of the innovation is shown. As illustrated, an example case (or cover) 500 for a movie disk (e.g., DVD disk) is shown. In this example, the cover 500 can be equipped with a video system 502 (including circuitry, memory, processor, power source (e.g., battery, solar), etc.) that can be used to render a review, preview, instruction, etc. related to a particular product. Here, the rendering via system 502 can be a review of the movie The NowStalgic Toy Story. In other aspects, it can be a preview of the movie. Still other aspects can include trailers, promos, ads or the like of upcoming features, upcoming products, etc.

As shown, a push button (or other means) can be provided that effects triggering of the review or other rendering. Although not shown, other aspects can employ motion sensors, switches, voice activation, proximity sensors or the like to trigger rendering of information via a display. While this aspect is directed to a system 502 embedded or attached to a disk cover, the features, functions and benefits of video or multi-media content rendering related to other products are to be include within the scope of this innovation. Some of these concepts are described in later figures.

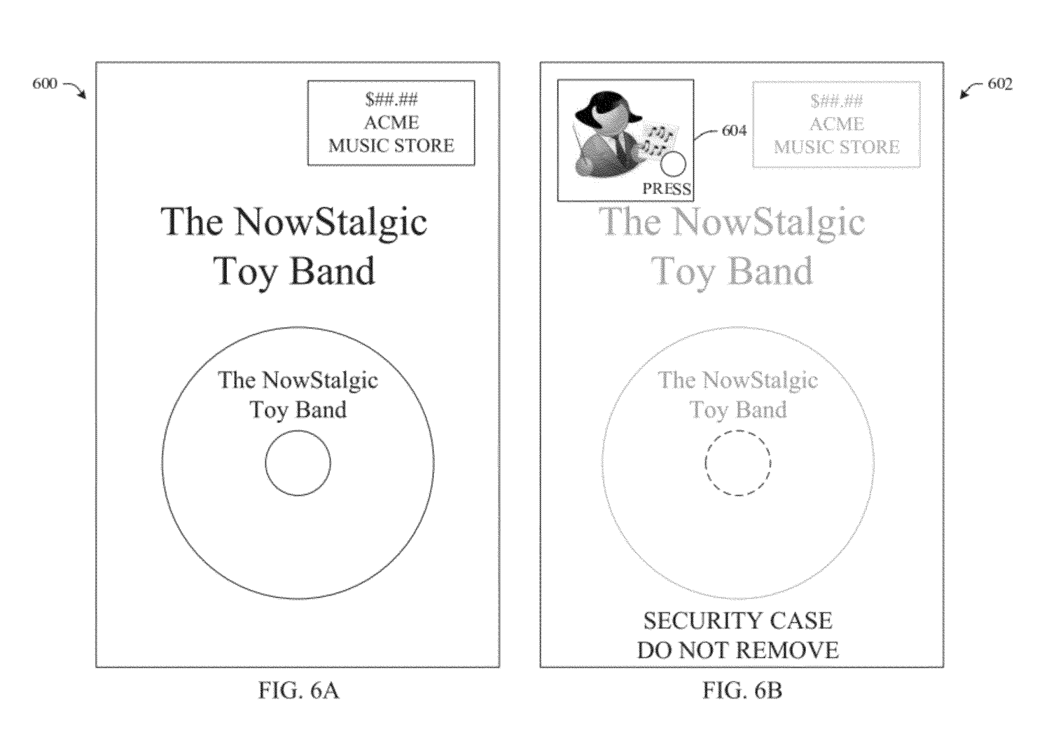

Referring now to FIGS. 6A and 6B, an alternate aspect of the innovation is shown. Turning first to FIG. 6A, a music disk package 600 is shown. FIG. 6B illustrates an example security case or covering 602 that is configured to encase the packaging 600. It will be appreciated that other security cases (e.g., strap-based) are to be included within the scope of the innovation. As will be understood, these security cases (e.g., 602) are often used for products including, but not limited to, music compact disks (CDs), movie DVDs, video games, or the like. These are but example uses of the innovation's features, functions and benefits.

As illustrated in FIG. 6B, the example security case (e.g., clear plastic case) 602 can be equipped with a video or multi-media system 604 capable of displaying a review, preview, sample tracks, etc. related to the product. As described with regard to FIG. 5, the system 604 can be equipped with a push button triggering mechanism as well as other switching means, motion, sound or proximity sensors as desired.

In aspects, the system 604 can be pre-programmed with content and pre-applied to a disk (or product) package. In other aspects, the case 602 can be installed onto the packaging and content programmed thereafter. Still further, content communication means can be programmed into the product such that “generic” cases can be applied to most any packages. In these embodiments, content can be conveyed to the case and rendered via system 604. Here, as the case is used with different products, the content can be automatically updated or changed.

In aspects, content can be transferred wirelessly via Bluetooth, Internet, network, RFID or other available means. Still further, packaging 600 and case 602 can be equipped with mating contacts or other communication means configured to transfer content from the packaging to the case. As will be understood, these aspects enable cases (e.g., 602) to be generically applied to most any packaging. Still further, video systems (e.g., 604) can be applied to most any package (e.g. via adhesives, mechanical means, magnetically clipping on, or the like) so as to enable retrofitting video means to products. It will be appreciated that this retrofit-ability enables the innovation to be used on most any product sold or displayed.

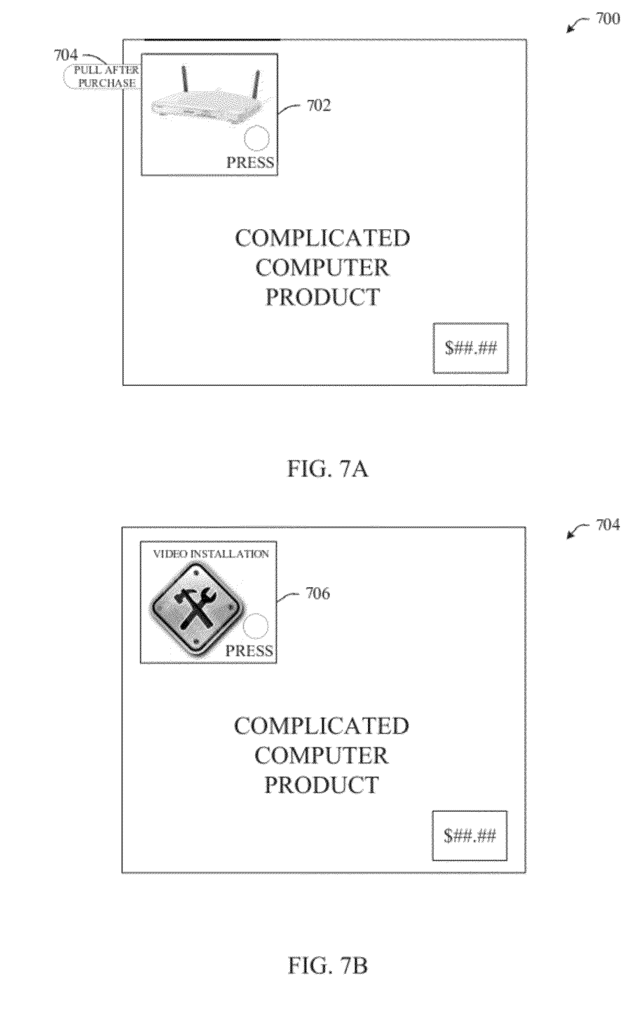

FIG. 7A illustrates yet another example aspect of the innovation 702. Here, a multi-media system 702 can be employed to display a product review, preview, instructions, etc. Optionally, a pull-tab 704 (or other toggling mechanism) can be employed to switch content. For example, as shown, the tab can be marked “pull after purchase.” Here, as shown in FIG. 7B, once removed, the multi-media system can switch from a product preview to an instructional video that explains how to install or set-up a complicated computer product, in this example. While a pull-tab is used to toggle between content, alternative aspects can employ switches, sensors or the like to determine which content to display. For example, manual switches can be employed that enable a user to select content. In other aspects, the system can detect an open box, thereby displaying instructions rather than reviews, previews, for example. These and other aspects are to be included within the scope of this specification.

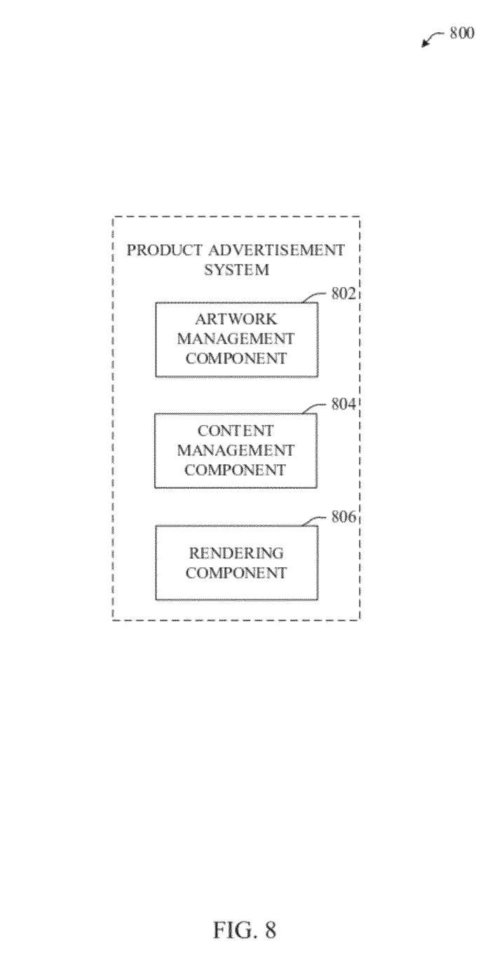

FIG. 8 illustrates an example block diagram of another embodiment of a product advertisement system 800 in accordance with aspects of the innovation. Generally, system 800 can include an artwork management component 802, a content management component 804 and a rendering component 806. In one aspect, the artwork management component 102 can include a frame or other decorative (or informative) indicia as desired or appropriate for advertisement of a product or group of products.

The content management component 804 can include a system that facilities efficient programming or loading of electronic content for rendering, for example via a display or monitor (e.g., rendering component 806). Essentially, system 800 can enable a user to easily and efficiently personalize a product (or service) advertisement system by merely changing artwork and/or content. The artwork can be a tangible frame or other desired artwork. Additionally, the artwork can be electronically projected or rendered, for example, by way of a liquid crystal display (LCD) or other suitable device. In aspects including a pre-render component 208, an electronic frame can be created based on information provided in connection with content by pre-render component 208.

In specific aspects, content described herein can be protected or “encrypted” as desired or appropriate. For instance, particular embodiments employ system-specific memory cards that are configured with particular pin or contact arrangements so as to effect content access. In one aspect, a “standard” SD memory card can be employed to transfer content. However, in this aspect, it is possible to assign or re-assign each contact or pin on the SD card as desired so as to require a specific “decoding” of the content for rendering. Other encryption techniques can also be used, such as public/private key encryption, etc. For instance, audio, video, positive and negative power can be rearranged to be specific to a desired configuration, thereby “encrypting” the content for a particular system.

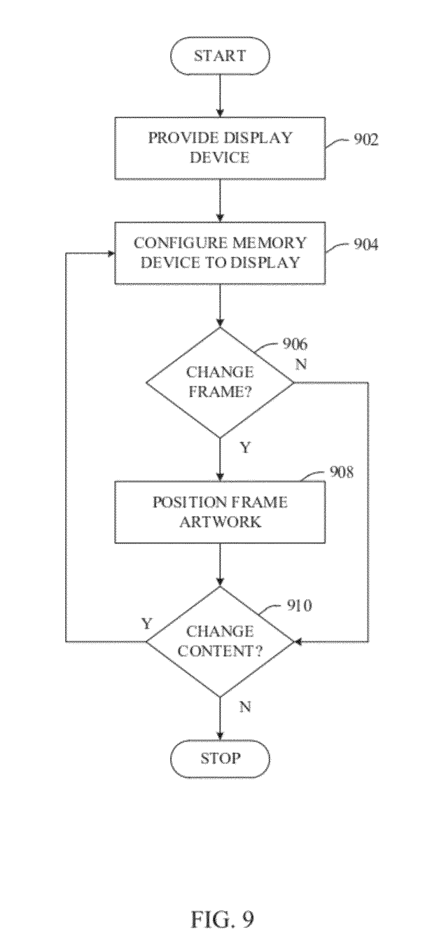

FIG. 9 illustrates a methodology of configuring a product advertisement system utilizing a frame or border in accordance with an aspect of the innovation. At 902, a display device such as an LCD monitor or the like can be provided for display of an advertisement. At 904, content can be configured for rendering. For example, a system-specific SD-like memory card can be employed to swap or otherwise load content (e.g., video and/or audio). It will be understood that most any memory mechanism can be employed to load or insert content into the system, including, but not limited to, those described herein.

A decision can be made at 906 to determine if the frame (or border) should be changed. If so, artwork can be positioned, inserted, replaced, updated, etc. at 908 as shown. For example, a replacement tangible border frame can be replaced or otherwise posted/attached onto the display device. In other aspects, electronic border content can be changed as appropriate or desired.

At 910, a decision can be made to determine if the content is to be changed. For example, if a user desires to change a rotating advertisement program to reflect that of a different product, an SD card or other memory (e.g., “system-encrypted” card) can be inserted at 904 such that new content can be retrieved and ultimately rendered. It is to be understood that the methodology described herein can be repetitive as a user desires to change or modify content and/or a border item.

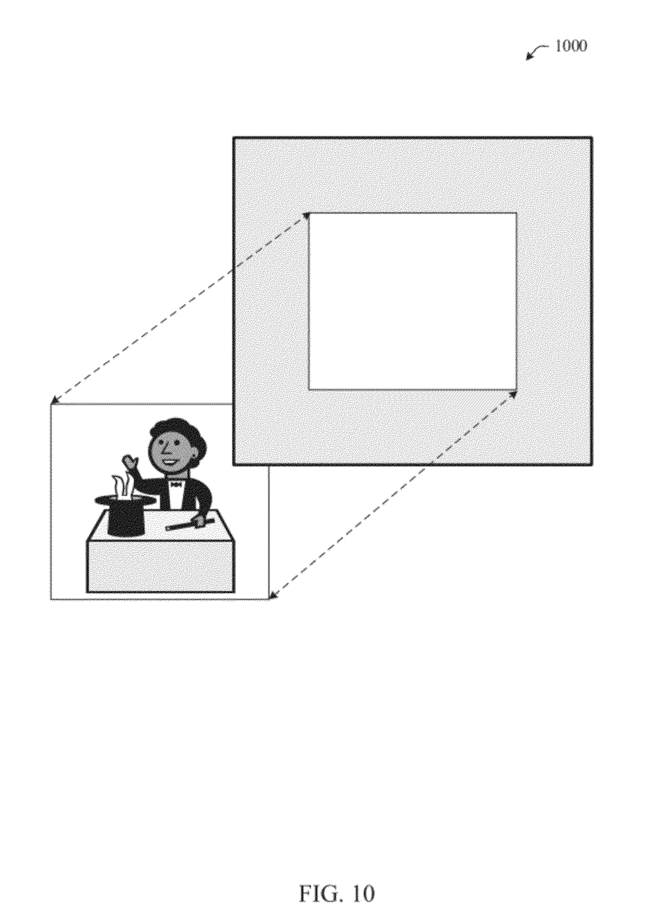

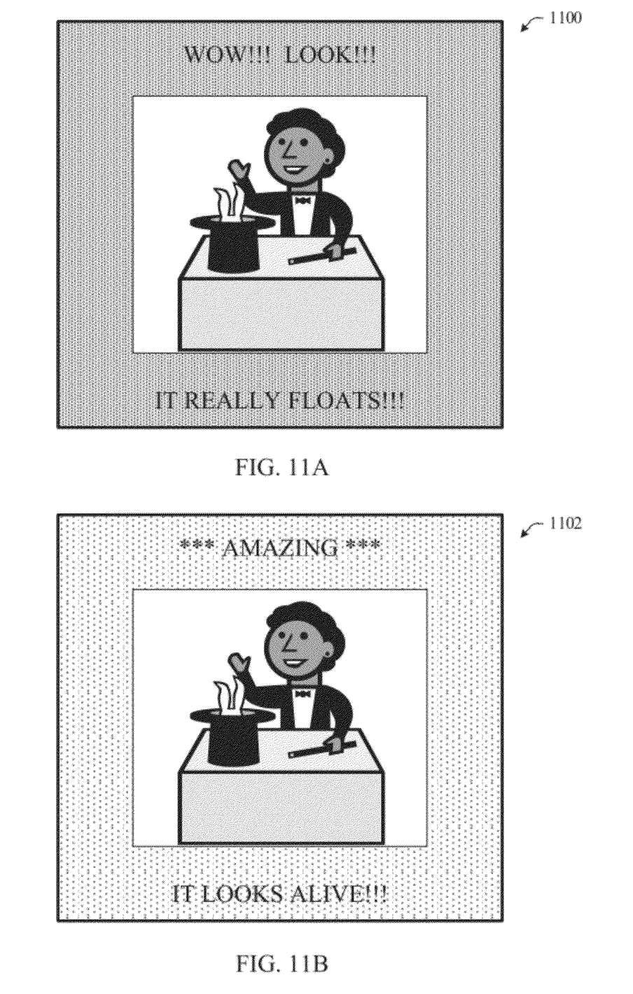

Referring now to FIGS. 10, 11A and 11B, example systems are provided so as further illustrate the innovation. It is to be understood that these figures are included to provide context and perspective to the innovation and are not intended to limit the scope of the innovation in any manner. Accordingly, other examples exist without departing from the spirit and/or scope of the innovation and claims appended hereto.

The example system 1000 of FIG. 10 illustrates that a border can be removable applied to a display mechanism. In aspects, the border can be applied using adhesives, magnets, clips, slides or other suitable attachment means. While a tangible frame or border is shown, it is also to be understood that the border or indicia displayed thereon can be rendered electronically as appropriate or desired.

FIGS. 11A and 11B illustrate aspects of systems 1100 and 1102 respectively that depict alternate borders being applied to a display mechanism or rendering component. As shown, the border and indicia thereon (e.g., words) can be modified so as to describe or otherwise advertise a product or group of products. Of course, other examples exist which are to be included within the scope of this innovation and claims appended hereto.

While specific placements, configurations and orientations are shown and described herein, it is to be understood that alternative aspects can include alternative placements, configurations and orientations. These alternatives are to be included within the scope of the specification herein. Also, while video is described, it is to be appreciated that video, audio or combination thereof can be employed in alternative aspects.

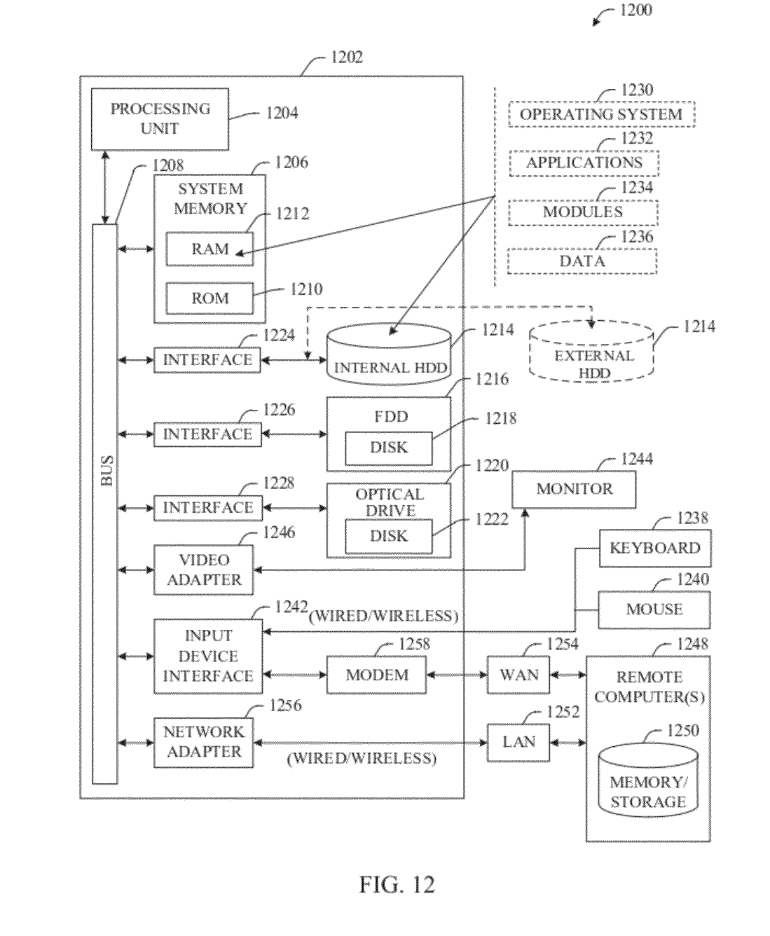

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

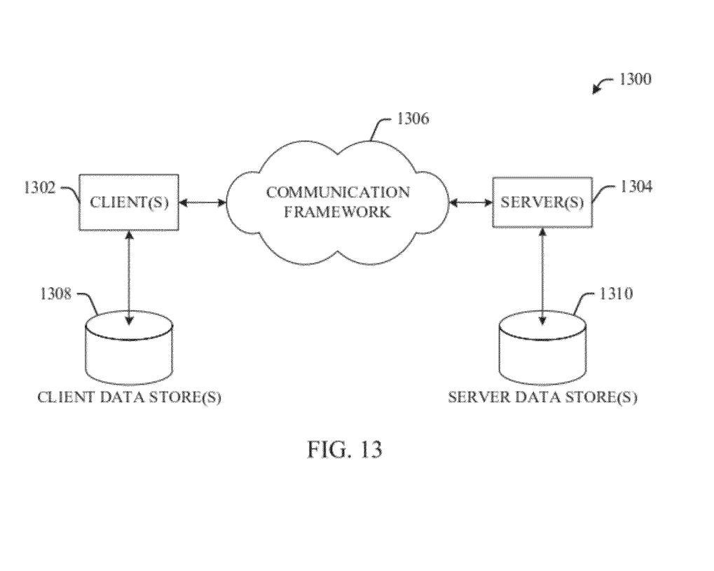

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates advertising of a product, comprising:
a rendering component that visually displays an item of content associated with the product; and
a content management component that provides the item of content to the rendering component.

2. The system of claim 1, wherein the content management component comprises an activation component that employs a motion sensor, wherein the rendering component visually displays the item of content based at least in part on a signal received from the activation component in response to motion detected by the motion sensor.

3. The system of claim 1, wherein the content management comprises a content selection component that determines the item of content from among a plurality of content items.

4. The system of claim 3, wherein the content management component comprises an association component that modifies the plurality of content items to comprise one or more items based on content associated with one or more related products.

5. The system of claim 3, wherein the content selection component determines the item of content based at least in part on input from one or more of a user or potential customer.

6. The system of claim 1, wherein the content management component comprises a location component that determines location data associated with the product, wherein the item of content is based at least in part on the location data.

7. The system of claim 1, wherein the content management component comprises a pre-render component that modifies the item of content to include additional information.

8. The system of claim 1, wherein the content management component comprises a communication component that receives information associated with the product, wherein the item of content is provided based at least in part on the received information.

9. The system of claim 8, wherein the information associated with the product comprises a product identification, wherein the content management component determines the item of content based on the product identification.

10. The system of claim 9, wherein the product identification is received via a radio frequency identification (RFID) device associated with the product.

11. The system of claim 9, wherein the product identification is one or more of a bar code or a stock-keeping unit (SKU) code.

12. The system of claim 1, wherein the item of content comprises a prize code redeemable for a reward.

13. The system of claim 1, wherein the system is included within one or more of the product, a packaging of the product, or a case in which the product is contained.

14. The system of claim 1, wherein the system is included as part of a vending or dispensing machine that vends or dispenses the product.

15. The system of claim 1, further comprising an artwork management component that provides promotional information through one or more indicia based at least in part on the product.

16. A method of providing advertising, comprising:
providing a rendering device that displays one of a plurality of content items associated with a product;
configuring at least one of a plurality of content items for rendering via a rendering device, wherein the plurality of content items comprises at least a preview related to the product and instructional material related to the product;
determining a selected content item of the plurality of content items to render via the rendering device; and
rendering the selected content item via the rendering device.

17. The method of claim 16, further comprising storing the plurality of content items on a removable memory.

18. The method of claim 16, further comprising receiving the selected content item from a remote server.

19. The method of claim 16, wherein rendering the selected content item comprises detecting motion near the rendering device, wherein rendering the selected content item is in response to the detected motion.

20. A product-based advertising system, comprising:
a content management component that queries one or more of a bar code or a radio frequency identification (RFID) device associated with the product for a product identifier, wherein the content management component determines an item of content based at least in part on the product identifier; and
a rendering component that renders the item of content via a display.
